(19) United States
(12) Patent Application Publication
(10) Pub. No.: US 2021/0306425 A1
(43) Pub. Date: Sep. 30, 2021

(54) METHOD AND APPARATUS FOR IMPROVING ENERGY EFFICIENCY OF SENSING TECHNOLOGY

(71) Applicant: Sensyne Health Group Limited, Oxford (GB)

(72) Inventor: Robert BAUGH, London (GB)

(21) Appl. No.: 16/465,516

(22) PCT Filed: Nov. 30, 2017
(86) PCT No.: PCT/GB2017/053617

§ 371 Date: May 30, 2019

(30) Foreign Application Priority Data
Dec. 1, 2016 (GB) 1620442.2

(51) Int. Cl. H04L 29/08; G05B 17/02; H04W 4/38

(52) U.S. Cl. CPC H04L 67/125; H04W 4/38; G05B 17/02

(57) ABSTRACT

A sensor network comprising a controller and a plurality of sensor devices configured to be distributed about an area and to communicate via a wireless communication link with the controller. Each sensor device is arranged to sense a parameter and to provide to the controller, via the wireless communication link, sensor data indicating a sensed parameter value and each sensor device is configured to report the sensor data to the controller according to a reporting condition associated with the each sensor device. The controller is configured to obtain location data indicating the location of each of the plurality of sensor devices and obtain said sensor data from each of the plurality of sensor devices to determine a reporting command for a selected sensor device based on the obtained sensor data and the corresponding location data; and to provide the reporting command to the selected sensor device to update the reporting condition associated with the selected sensor device.

### FIELD OF INVENTION

The present invention relates to sensing technology, and more particularly to methods and apparatus for improving the energy efficiency of sensors, and more particularly the energy efficiency of spatially distributed networks of sensors.

### BACKGROUND

Sensor networks are increasingly prevalent. They may be used to monitor parameters such as temperature and humidity in facilities such as warehouses, work places, and cold stores.

Often, where a certain minimum standard must be met for regulatory or other purposes, there can be a tendency to deliberately overshoot that minimum standard to ensure compliance. As a result, energy and money are wasted. This can cause both environmental damage and financial waste.

Sensor networks can thus provide significant environmental benefits, because they can enable the operators of such facilities to monitor compliance with standards more accurately—thus avoiding the need for costly and wasteful overshoot.

The sensor networks themselves however may be perceived as an unnecessary cost. A significant factor in the cost of such networks is their maintenance—the need to send engineers to the sites at which they are installed and replace or recharge batteries and so forth. The same may be true of other data monitoring systems such as those used to track the location of vehicles and the passage of foot traffic, or the occupancy of car parks, or venues such as concert halls.

### SUMMARY

Aspects and examples of the invention are set out in the appended claims and aim to address at least a part of the above described technical problem.

Embodiments of the disclosure may aim to reduce the energy used per byte of data transmission in sensor networks, and thus to reduce the financial cost of maintaining such networks. This may be accomplished, at least in part, by extending battery life and/or allowing the use of energy harvesting technology to obviate or reduce the need to rely on batteries.

These technologies are of particular utility in wireless sensor networks.

### BRIEF DESCRIPTION OF DRAWINGS

Embodiments of the present disclosure will now be described, by way of example only, with reference to the accompanying drawings in which:

FIG. 1 shows a schematic diagram of a sensor network;

FIG. 2 is a flow chart indicating a method of operating a sensor network;

FIG. 3 is a flow chart indicating a method of operating a sensor network;

FIG. 4 is a flow chart indicating a method of operating a sensor network; and

FIG. 5 is a schematic diagram of a plot of values useful in understanding certain methods of the present disclosure.

In the drawings like reference numerals are used to indicate like elements.

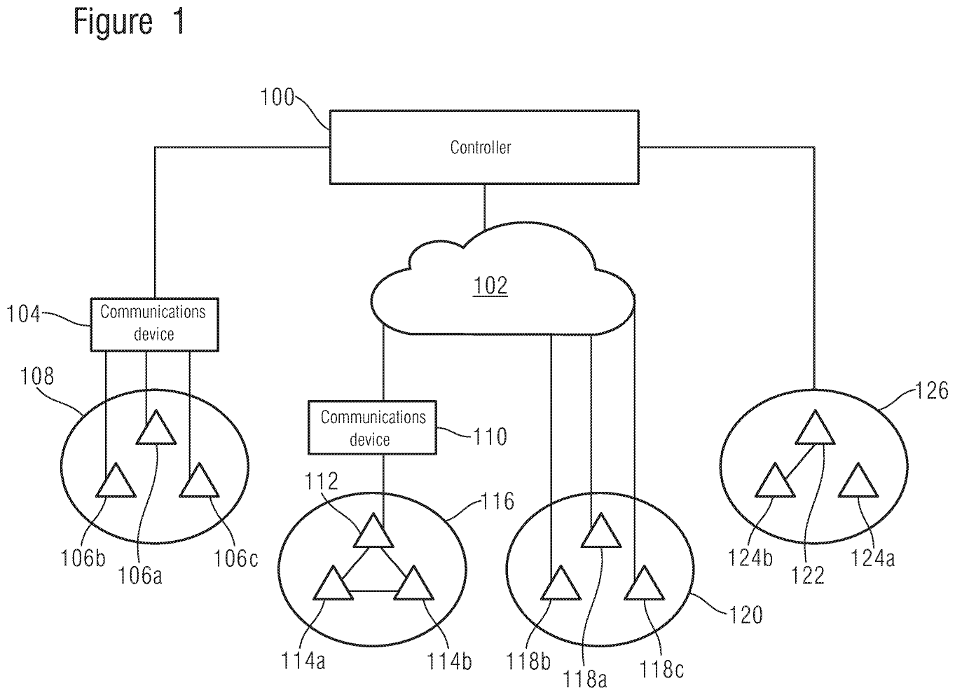

FIG. 1 shows a sensor network according to the present disclosure. As illustrated in FIG. 1 this sensor network comprises sensor devices which are arranged to sense a parameter, such as a parameter of their local environment.

The sensor network also comprises a controller which is configured to determine a reporting condition upon which each sensor will report sensor data to that controller, and to send commands to the sensor devices to configure them accordingly. The reporting condition applied at each sensor device may be determined based on sensor data obtained from other sensor devices, or stored (e.g. historical) sensor data, which may have been obtained from that sensor device itself.

Also shown in FIG. 1 are communications devices and a wide area network (WAN).

The sensor devices may be spatially distributed about an area—such as around a building or other facility (in which they may be in outdoors or in enclosed areas (e.g. indoors). The sensors may also be mobile in the sense that they may be carried in or on vehicles, such as on-highway vehicles (e.g. cars, buses and trains) or off-highway vehicles (such as materials handling vehicles and heavy plant machinery).

The sensor devices are configured to communicate, via a wireless communication link with the controller. As illustrated the wireless communication link may provide direct communication, or indirect communication with the controller. Indirect communication can be mediated by an intermediate communications device and/or by the WAN. For example the group of sensor devices in the area 126 are configured to communicate with the controller itself directly—e.g. data may be transferred to the physical layer by those sensor devices which generate physical layer signals (such as radio signals) for reception by the controller. The controller can then receive and decode those physical layer signals. As another example, the sensor devices in the area 120 communicate via a wireless link with WAN which then provides communication to the controller. If they are used, the communications devices may also communicate directly with the controller (whether by wired or wireless communication), or via the WAN.

In the network illustrated in FIG. 1, each sensor device is arranged to sense at least one parameter, which may be a parameter of its local environment (such as ambient temperature, wind speed, humidity, pressure, or the level of a gas such as CO₂ or oxygen, the level of a contaminant such as CO, NOx, pollen, and other particulates).

Health monitoring sensors may also be used, for example spirometry sensors for sensing physiological parameters. Examples of physiological parameters include exhaled carbon monoxide, and other spirometry measurements. Another example of a physiological parameter is heart rate and/or blood pressure (which may be measured using a pulse oximeter or other cardiac function sensor. Sensors may also be arranged to sense drug dosing, e.g by detecting operation of an inhaler or other drug delivery device (e.g. the sensed parameter may comprise a drug dose quantity or frequency.

Irrespective of the nature of the parameter itself, the sensor device is operable to provide sensor data indicating the value of this sensed parameter to the controller. The sensor devices are each configured to report the sensor data to the controller according to a reporting condition which is typically stored at each sensor device. This reporting condition may specify a time interval at which the sensor devices are to provide the sensor data to the controller. In the first instance, e.g. when initially deployed or in response to some reset condition such as loss of power or another trigger, the sensor devices can be configured to provide sensor data indicating this parameter to the controller at some selected reporting frequency (e.g. a number of reports in a given time interval). Later reporting conditions may be based at least in part on the value of the sensed parameter, for example whether the value or its rate of change is within an allowed range. These reporting conditions may also have some temporal characteristic, that is to say the condition placed on the sensed value, and/or the reporting frequency may vary periodically (e.g. with time of day, day of the week, month, season etc.)

The controller comprises a communication interface adapted to communicate with the sensor devices. It may also comprise a data store storing location data identifying the location of each of a plurality of the sensor devices. The controller illustrated in FIG. 1 is configured to obtain sensor data from each of the plurality of sensor devices, and to associate it with location data obtained from this data store.

The controller is configured to use the location of each sensor device, and the sensor data provided from each device to determine a spatial map of the parameter in the area about which the sensors are distributed. This spatial map may also comprise an indication of the range of values of sensor data which may be expected at each location in the map—this indication of range may be provided by a minimum and maximum value, or any other indication of data value spread such as measures based on variance (e.g. a confidence interval or standard deviation), quartiles, or other statistical measures of a spread of data. The controller may also be configured to establish a temporal record of this sensor data (and/or its associated range) at each location to provide an indication of expected temporal behaviour of that sensed parameter.

The controller is configured to use the information derived from these spatial (and/or spatiotemporal) characteristics of the sensed parameter to determine reporting conditions to be applied at each sensor device. In the first instance, each particular sensor device may sense the parameter at some known or default sampling rate. It may also report this sensor data to the controller at a known or default reporting rate (e.g. providing a selected number of reports in a given time interval). The controller is configured to use the reported sensor data to establish an expectation value of the sensed parameter at the location of each sensor device. For example this may be a measure of the central tendency of the parameter such as its mean or median. It is also configured to determine a measure of the expected spread of the values of that parameter.

The controller may comprise a data fitting capability, adapted to fit a spatial or spatiotemporal model to the sensed parameter data. For example, the sensed parameter data may be expected to be temporally stable (e.g. constant over time), but to have some smoothly varying spatially continuous form. In this example, the controller may be configured to use the location data to fit a spatially defined function to the sensor data. For example, the spatially defined function may comprise a one-dimensional function (such as a curve) which defines the temperature variation at a series of points along an elongate series of sensor devices (such as may be distributed along an elongate area such as a corridor, a tunnel, or a railway carriage). As another example, the spatially defined function may comprise a two-dimensional function (such as may be associated with the monitoring of a parameter across a surface, or at a series of locations around a room). Three dimensional 3D spatial mapping may also be provided—in which case the function used for the fitting may define a value of the parameter as a function of 3D spatial co-ordinates. In each of these examples, the controller may be configured to fit a smoothly varying function such as a polynomial to the sensor data to provide a map of its variation. Any spatial model may be used, and the model which the controller is configured to use is typically selected based on at least one of: the characteristics of the parameter, and the geometry and size of the area in which the sensor devices are deployed.

It will be appreciated in the context of the present disclosure that temporal variations may also be taken into account. These variations may be periodic in some way, so the controller may be configured to use periodic functions (such as sinusoids, e.g. Fourier series) to fit the temporal variations. It will thus be appreciated that the spatial map of the sensed parameter can vary with time according to a temporal model of the sensed parameter for each of the plurality of locations. The controller can be configured to use any appropriate temporal model in this fitting procedure. It will also be appreciated that any appropriate fitting procedure may be used to obtain the fitted data. It will be appreciated in the context of the present disclosure that where there is thought to be no spatial correlation between the parameters sensed at individual sensor devices only temporal fitting may be used and this may be applied individually to the data obtained from each individual sensor alone, or it may take into account the data from more than one of the sensors, e.g. to establish some group temporal characteristic.

In operation, the controller obtains sensor data from each of the plurality of sensor devices according to some default or selected reporting condition. It uses this data to establish an expectation value of the sensor data from each sensor device. This may be a simple time average, or developed using a fitting procedure as described above (whether or not some temporal variation is included in the model). It also establishes a measure of the expected spread of data values from each sensor. Once a minimum number of values has been obtained (or the measured spread has fallen below a selected threshold), the controller may send a reporting command to the sensor device to cause it to reduce its reporting rate (e.g. the rate at which sensor data is transmitted from the second sensor device to the controller). For example this may comprise a command to simply reduce the reporting rate but continue to report at intervals. Alternatively or additionally it may comprise a command to report the sensed parameter in the event that a parameter value outside an expected range of values is sensed. This range may be based on the expected spread.

Subsequently, the controller may compare the sensor data received from a first sensor device with an expectation value for that sensor device and, in the event that the two do not match, it may send a reporting command to a second (different) sensor device to cause it to provide additional sensor data to the controller. The match may be judged on the basis of a selected tolerance, which may be based on the spread or some other measure of sensor accuracy.

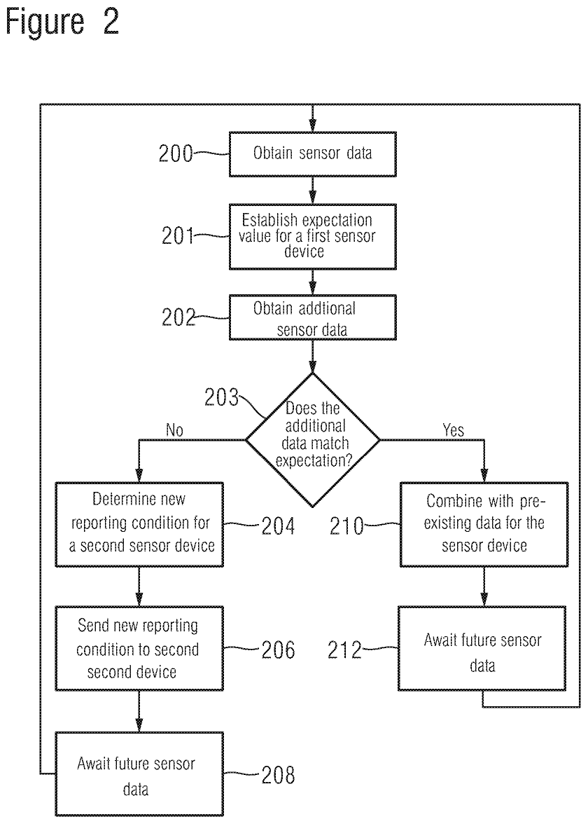

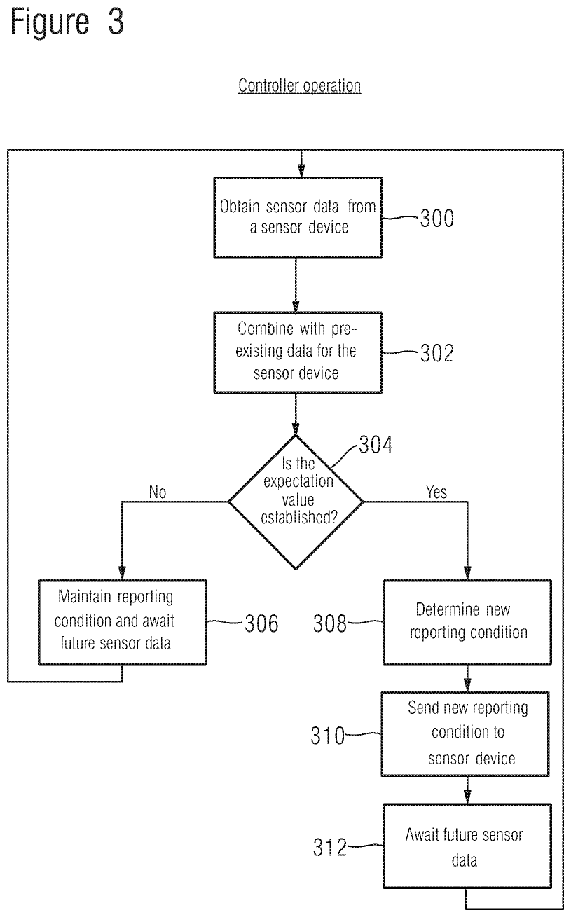

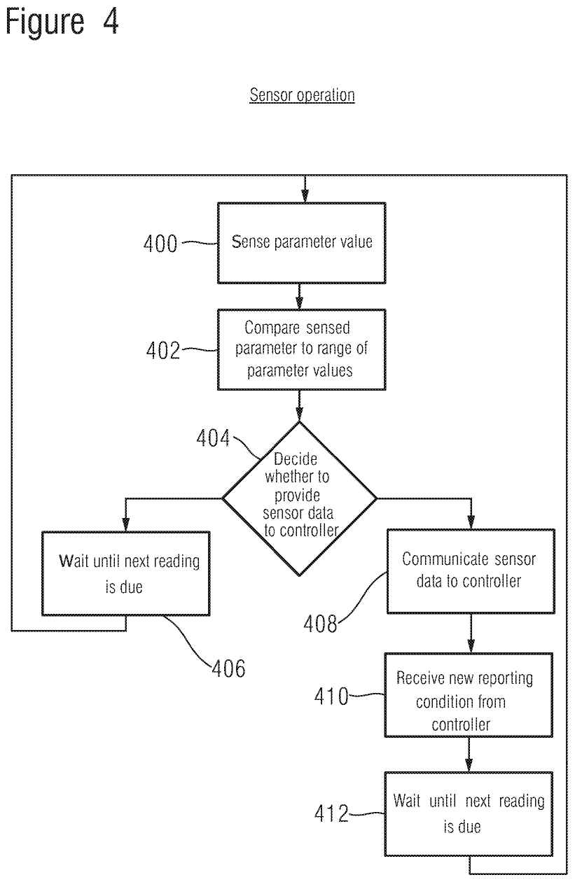

For example, in response to receiving new sensor data, the controller may determine a new reporting condition (or conditions) to send to sensor devices as explained below with reference to FIG. 2, FIG. 3, and FIG. 4. As one example, in response to receiving sensor data, the controller may determine whether that new sensor data is anomalous in some way. To do this, the controller may check whether the sensor data matches an expectation value for at least one of: (a) that sensor; (b) the location at which the data was obtained; or (c) the time at which the data was obtained. In the event that the controller determines that the sensor data is anomalous, it determines a new reporting condition for the sensor device which sent the data, or for another sensor (or sensors) selected based on the location of that sensor. For example, the controller may select a nearest neighbour or group of nearest neighbour sensors. The controller then sends a reporting command to the selected sensors to set a new reporting condition at those sensors. The command could be configured to increase either the reporting rate of the selected sensor device(s), or the sampling rate they employ so that more measurements are associated with each item of data reported to the controller. As another example, the command may cause reporting to occur at a fixed rate for a selected interval or until an expectation value is established, before reverting to conditional reporting (e.g. reporting only if the sensed parameter does not match an expectation value).

FIG. 2 shows a flow diagram representing one method of operating a sensor network such as that described above with reference to FIG. 1.

As illustrated in FIG. 2, the controller obtains 200 sensor data from each of the plurality of sensor devices. This may be done by the sensor devices transmitting data to the controller in accordance with the reporting condition stored at each of those sensors device (e.g. as set by the most recent reporting command).

The controller then establishes 201 an expectation value for the first sensor device based on sensor data received from the sensor network. For example, by using a fitting procedure such as one of those described above. The controller then continues to obtain 202 additional sensor data from the sensor network, e.g. in accordance with the existing reporting conditions.

The controller then compares 203 the additional data with the expectation value for that first sensor. In the event that the sensor data matches the expectation value, that sensor data may be combined 210 with the previous sensor data. This combination may generate a new expectation value. For example, if the expectation value is based on a time average, it may be done by adjusting that average based on the new data. As another example, if the expectation value is based on a spatial or temporal fitting procedure as explained above, the controller can incorporate the new sensor data into that fitting procedure. In the event that combining the new data with the existing data and repeat the fitting procedure. In the event that this process causes more than a threshold adjustment in the expectation value for the first sensor device, the controller may send a reporting command to that sensor device to update the reporting condition at that device based on the adjusted expectation value. The controller then waits 212 for new sensor data from the sensor devices.

On the other hand, in the event that the comparison 203 indicates that the sensor data for the first sensor device does not match the expectation value, the controller determines 204 a new reporting condition for a second sensor device and sends 206 a reporting command to that second sensor device to increase the reporting rate and/or sampling rate of that second sensor device for a selected interval before reverting to conditional reporting (e.g. reporting only if the sensed parameter does not match an expectation value). The controller may select the second sensor device based on the location of the first sensor device and the second sensor device. For example it may select the nearest neighbour of the first sensor device. As another example, it may select the second sensor device based on data indicating expected behaviour of the first sensor device—for example, if the first sensor device is in a particular type of location the controller may select a second sensor device (or devices) in that same type of location (inside/outside a building, adjacent to an HVAC unit such as a radiator, adjacent to a window or door of a building, on a south facing wall, at similar altitude, carried on or in the same type of vehicle, etc.)

The process described above is meant as an example only—a number of variations are contemplated within the scope of the present disclosure. For example, the sensor data used to establish the expectation value may be obtained from an external data source, such as a forecast—e.g. a weather forecast. The same is true of the additional data 202. For example, the controller may be configured to obtain that additional data from a data source other than the sensors and to compare 203 it with the expectation value associated with one or more of the sensor devices in the network. In the event that it matches, this external data may simply be discarded or incorporated into the expectation value as described above. In the event that it does not match, the controller may send reporting commands to one or more of the sensor devices as explained above. It will be appreciated that such external data may also comprise location data (e.g. the forecast may be associated with a map), and the controller may use this location data to select the sensor devices which are to receive a new reporting command

FIG. 3 shows another method of operating a sensor network such as that described above with reference to FIG. 1. This process may occur at initial set up of the sensor network or after any significant change, such as physical changes in the vicinity of the sensor network.

As illustrated, the controller obtains 300 sensor data from a sensor device. The sensor data is used to determine an expectation value for the sensor device according to any one of the methods described herein. The controller then determines whether or not the expectation value is established for a first sensor device. This may be done based on a spread of the sensor data and/or the number of items of sensor data collected from that sensor device. For example, the controller may determine that the value is established in the event once a threshold number of items of sensor data have been received from that sensor device. As another example, the controller could use both the number of data points and the spread of the data. This may be done based on the ratio of the number of data points to a measure of the spread, such as a statistical moment (e.g. the variance, standard deviation) or a measure of a confidence of a fitted model (such as a confidence interval or the sums of squares of errors about a fit). This may provide an indication of reliability of the expectation value, like a standard error or similar, and when this indication meets a threshold the controller may determine that the expectation value has been established.

Until the expectation is established, the controller may allow the sensor devices to maintain reporting rate (or send them a command to increase it).

Once the expectation value is established, the controller determines 308 a new reporting condition and sends 310 a reporting command to the sensor device to set this condition. The controller then awaits further communication from the sensor device, according to this condition.

To determine whether the expectation value is established, the controller may take into account data from an external data source. For example, if the external data does not match an expectation value determined from the sensor data, the controller may allow the sensor devices to maintain reporting rate (or send them a command to increase it). It may also send them a reporting command to set a reporting condition based on the external data.

FIG. 4 shows a flow diagram representing a method of operating a sensor device such as one of those illustrated in FIG. 1.

The sensor device senses 400 a parameter value and checks it against the reporting condition stored at the sensor device. For example it may compare the sensed value to an allowed range associated with the parameter. The allowed range may take into account time as explained above. The sensor device then determines, based on this comparison, whether to provide the sensor data to the controller. In the event that the value is outside the allowed range, the device provides the sensor data to the controller. Other reporting conditions may be applied by the sensor devices.

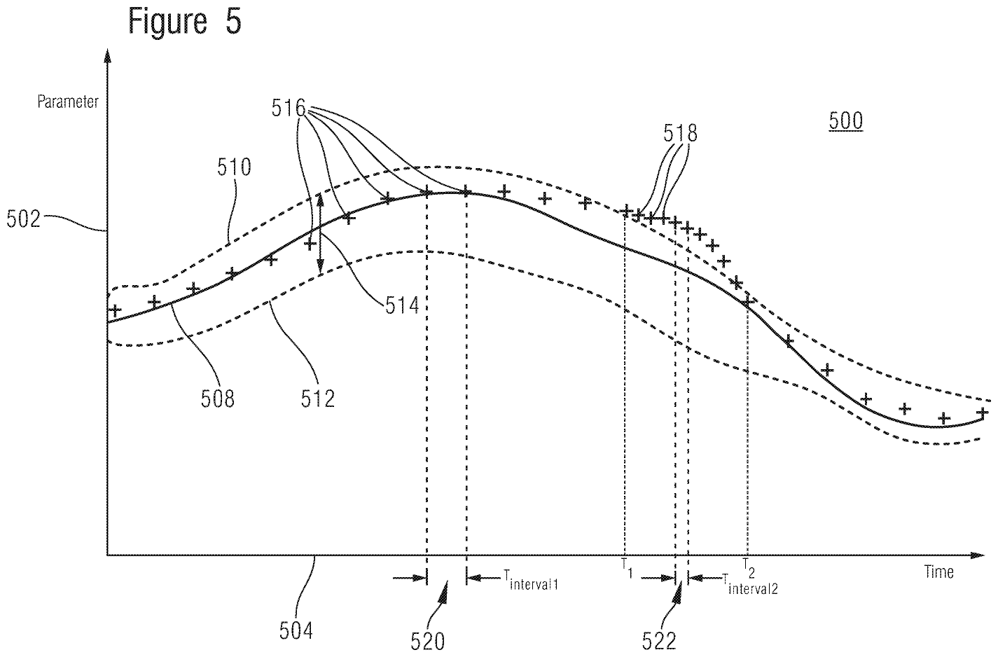

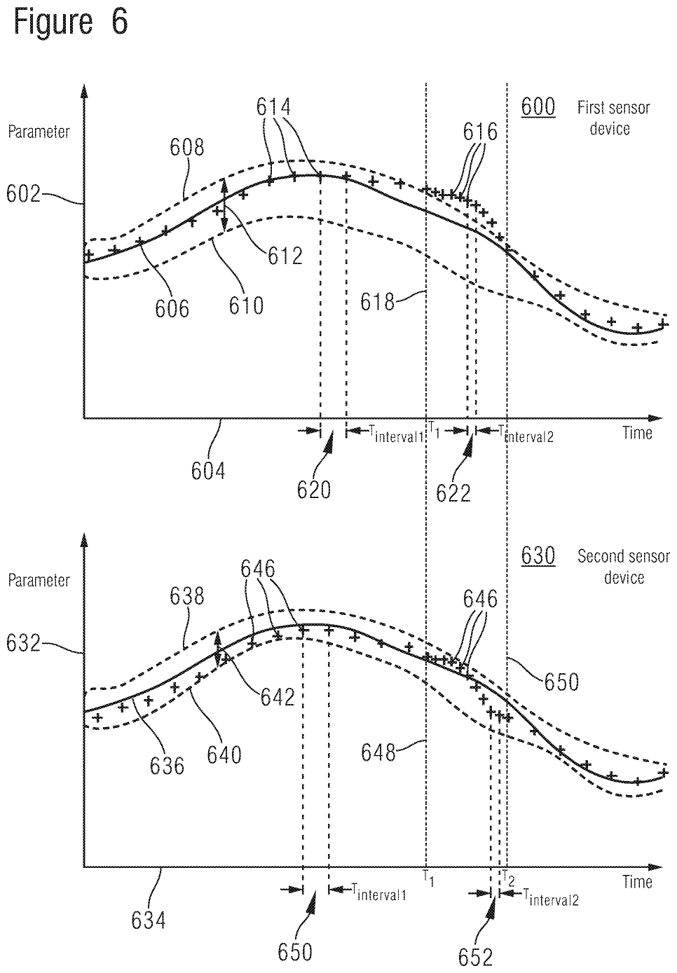

FIG. 5 is a visual representation of the data collected by a sensor device in the form of a plot of sensed parameter against time. The graph also shows a line representing the expectation value of the sensed parameter for this sensor device over a time frame. Further to this, there is a range of parameter values encompassed by the dashed lines that provide the range of parameter values in which the sensed parameter values from the sensor device are expected to fall at any given time. In the embodiment shown in FIG. 5, the range of parameter values is contained within the reporting condition the sensor device receives from the controller. This allows the sensor to compare the sensed parameter value to the range of values provided by the controller and determine whether to provide sensor data to the controller.

The range of values for a sensor device is determined by the controller and based on sensor data from the sensor device. The range may be based on a statistical moment of the sensor data; this could be, but is not limited to, the standard deviation, variance or range of the sensor data.

In FIG. 5 the sensor data falls within the range of values of the sensor data produced by the sensor device until T₁. The data points before this time (516) are not reported to the controller in line with the reporting command that the sensor device had previously received from the controller. At T₁, the sensor device senses the parameter and the parameter value lies outside of the confidence interval designated for the sensor device at that time.

The sensor device will compare the sensed parameter value at time T₁ to the range of values provided by the controller. Based on this comparison, the sensor device will report the sensor data to the controller via a wireless communication link. The controller will determine a new reporting condition for the sensor device and communicate the reporting command to the sensor device.

In the embodiment exhibited in FIG. 5, the new reporting condition includes decreasing the time interval between sensor device measurements from T_{interval 1} to T_{interval 2}. The new reporting command may also include instruction concerning how often to provide future sensor data to the controller, in the embodiment shown this instruction is to provide all future sensor data to the controller. The sensor device continues to take measurements at this increased frequency until T₂.

At T₂ the sensed parameter value is back within the range of values associated with the sensor device and the time. The sensor device will have transmitted all data points (616) to the controller and the controller performs the comparison of the sensor data to the range of values for the sensor device. The controller can then, based at least in part on this comparison, determine a new reporting condition and communicate a reporting command to the sensor device.

In the embodiment shown in FIG. 5, this last reporting condition returns the sampling rate of the sensor device to the previous sampling rate, before T₁. The last reporting command also provides instructions to only communicate data to the controller if and when a future sensed parameter value lie outside of the range or parameter values.

FIG. 5 is representative of one of many embodiments of the present invention. In the above embodiment the sensor device performs the comparison between new sensor data and the range of values associated with the sensor device. When the sensor device represented in FIG. 5 determines that a sensed parameter value is outside of the range of values, it communicates the sensor data to the controller. The controller could carry out a similar comparison of the sensor data to the range of values associated with the sensor device. This may occur if the controller had updated the range of values for the sensor device and not communicated the new range of values to the sensor device. This update could have been based on the most recent sensor data of other sensor devices.

The sensor device may report each data point of the sensor data to the controller, without comparing it to the range of parameter values, and the controller could perform a comparison to the range of values associated with the sensor device and time. The reporting condition of the sensor device could cause all collected sensor data to be communicated to the controller as it is collected such that the controller performs a comparison of all received sensor data to the range of values associated with the relevant sensor device. The controller may determine that the sensed parameter value at T₁ of the sensor data is not within the established range of values and determine a new reporting condition for the sensor device.

The example provided in FIG. 5 has shown the time variance of the range of values associated with each sensor device. Aspects of this invention can also be applied to mobile sensor devices, this means that the range of values can vary with spatial coordinates as well.

The range of values in FIG. 5 is based on the previous sensor data from the sensor device depicted. This range of values may be based on sensor data from at least one other sensor device where the selection of other sensor devices may be based at least in part on their location data. Selection based on the location data of sensor devices may determine the nearest sensor devices to the first sensor device. This leads to the range of values associated with a sensor device being based on a statistical moment of the sensor data from a selection of other sensor devices.

Although, the range of values has only been defined as a statistical moment of sensor data, in other embodiments of the invention, the sensor data of the selected at least one sensor device, including the sensor device to which the range of values is associated, could be used to create or refine a model of the sensed parameter, with the range of values represented by the confidence interval of the model. It should be obvious to the skilled person that the expectation value and range of values associated with each sensor device do not need to be a continuous function with respect to time or sensed parameter and may therefore be discrete in nature.

A reporting command may include an updated range of values from the controller. The range of values may be updated on a regular schedule or updated after the controller receives new sensor data.

Embodiments have been described in which the sensor device receives a reporting command that requests that all sensor data is transmitted to the controller and other embodiments where only sensor data that lies outside a range of values is transmitter to the controller. In both of these embodiments, the reporting condition may request that the sensor transmits a message, notifying the controller that the sensor device is still operational, and optionally the latest sensor data.

FIG. 6 presents a visual representation of the data collected by a first sensor device in the form of a plot of sensed parameter against time. It further shows the analogous graph of a second sensor device over the same time frame, demonstrating the controller changing the reporting condition of a second sensor device based on the sensor data of a first sensor device.

As in FIG. 5, at T₁ the first sensor device measures a parameter and the sensed parameter value lies outside the range of values associated with the first sensor device and the time. By any of the embodiments described above, the controller receives the sensor data from the first sensor device. In this figure, the controller determines a new reporting condition for the first sensor device; the corresponding reporting command is then communicated to the first sensor device. Additionally, the controller selects at least one other sensor device, a second sensor device in FIG. 6, and determines a new reporting condition for each of the at least one sensor devices. The controller then communicates these new reporting commands to each sensor device.

In FIG. 6, there is only one additional sensor device, labelled second sensor device. The controller selected the additional sensor device based on the sensor device location relative to the first sensor device. In the case of FIG. 6, a single nearest neighbour is selected and a new reporting command is communicated to the second sensor device. This is represented as an increase in sampling rate, to a similar rate as the first sensor device. It should be noted that the sensed parameter values sensed by the second sensor device never fall outside of the range of values determined by the controller for the second sensor device.

The controller may select more than one sensor device to update the reporting condition of. This could include the two nearest neighbours, communicating a reporting command to each to increase their sampling rate and/or reporting rate. This could allow the controller to interpolate between the sensor data of the nearest neighbours and compare the parameter value to the sensed parameter value of the first sensor device. This could be used to validate the sensor data received from the first sensor device.

FIGS. 5 and 6 present a range of values, representing a statistical moment, confidence interval or otherwise determined range of values. The skilled person will understand that these may be replaced by thresholds to which the above description could be modified.

In FIG. 1, the location data which is used by the controller to identify the locations of the sensor devices is obtained by retrieving it from memory. It will be appreciated however in the context of the present disclosure that such data may be sent to the controller from the sensor devices themselves (e.g. in the form of GPS co-ordinates), or it may be provided from some other resource—for example where an intermediate communications device is used, this may provide the location data and/or augment location data provided by the sensors. For example, the communication device may provide an indication of the position of each sensor device relative to its own location. It may also report its own location separately, or the controller may store data indicating the location of the sensor device so that the reported and stored data can be used together by the controller to determine the location of each sensor device. Other methods of obtaining the location data may also be used. The sensor devices themselves could be mobile, and the parameter sensed by the sensor could be the location, speed or acceleration. For example, the sensor may comprise a GPS device, accelerometer or other wireless location device.

In FIG. 1, the sensor devices are configured to sense a parameter of their local environment. However in some other embodiments the at least one sensed parameter may comprise a parameter of the sensor itself such as its position, speed or acceleration. In addition, or as an alternative, the sensor device may comprise a transducer configured to enable the sensor device to count events and/or to measure their frequency. For example the at least one sensed parameter may comprise a count or frequency of the passage of pedestrians or vehicles. This may be used, for example, to count traffic or the occupancy of a facility such as a vehicle parking area, or a venue in which groups of people may assemble.

The fitting procedures described herein may comprise linear regression, or may be based on non-linear merit functions. In some embodiments log-linear fitting is used. The nature of the fitting procedure and/or the merit function employed in any particular instance is selected based on the data model which is to be fitted to the sensor data. Examples of suitable fitting procedures may be found in Numerical Recipes in C; The Art of Scientific Computing; Third Edition Published 2007 by the Press Syndicate of the University of Cambridge, The Pitt Building, Trumpington Street, Cambridge CB2 1RP.

Communications device illustrated in FIG. 1 may comprise any communications interface for communicating over a wide area network and having the necessary data processing capability. It can be a Bluetooth gateway, a specifically designed electronic communications apparatus, a hand-held telephone, a laptop computer equipped with a mobile broadband adapter, a tablet computer, or any other device. Examples of communications interfaces include wireless personal area networks (WPANs) such as: INSTEON, IrDA, Wireless USB, Bluetooth, Z-Wave, ZigBee and Body Area Networks. Bluetooth is a particularly useful example of a short distance communication interface which may be used in examples of the present disclosure. Bluetooth is a wireless communication technology that uses a frequency-hopping scheme in the unlicensed Industrial Scientific-Medical (ISM) band at 2.4 GHz other examples of short distance communication may be used.

The wide area network described herein may be provided by any geographically dispersed communications network such as the internet and may comprise telecommunications networks which themselves may comprise packet switched and/or circuit switched elements such as POTS (plain old telephone services). It may comprise, at least in part, a cellular telecommunications network. Low power wide area networks, (LPWANS) may also be used. The wide area communications interfaces described herein comprise any interface operable to communicate over such a network. Examples of such interfaces comprise modems for communication over packet switched networks, which may comprise wired and/or wireless components. Such interfaces may comprise GSM, GPRS, 3GPP, LTE and other mobile communications interfaces.

It will be appreciated that devices such as the sensor devices and/or the communications devices described herein may be configured to determine their own location, for example using global positioning systems, GPS, devices and/or based on other methods such as using information from WLAN signals and telecommunications signals.

With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit. For example the functionality of the sensor and mobile telecommunications apparatus in the sensor system may be integrated into a single apparatus, or differently subdivided between two or more separable devices.

The above embodiments are to be understood as illustrative examples. Further embodiments are envisaged. For example, the sensor devices may be arranged to sense different parameters. For example, a first group of the sensors may be configured to sense a first parameter, and a second group of sensors may be configured to sense a second parameter. The controller may store data defining a relationship between the two parameters—for example this relationship may enable the controller to determine an expectation value for the first parameter based on the second parameter or vice versa. It will thus be appreciated that a method of the disclosure may comprise obtaining first sensor data relating to a first parameter from a sensor device of a first group of sensor devices; and establishing an expectation value of a second parameter based on the first sensor data, for example based on this stored relationship. The controller can then determine whether sensor data from a second group of sensor devices matches this expectation value. In the event that it does not match, the controller can send a reporting command to the second sensor devices to provide additional sensor data to the controller. This may enable the controller to adapt the collection of data for one parameter according to related conditions sensed by a different type of sensor. The relationship may comprise a mathematical mapping such as may be obtained by fitting a model to observed data. In addition or as an alternative it may comprise a logical mapping. This may comprise selecting a predefined expectation value of a first parameter by applying a logical condition to the value of a second parameter (such as whether it exceeds a threshold). This may comprise selecting between different models of such an expectation value for a first parameter by applying a logical condition to the value of a second parameter. This may enable reporting conditions to be adapted to take account of relevant external circumstances such as building occupancy level, the presence of daylight or rain, wind speed, traffic flow etc.

In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein. The data stores described herein may comprise volatile and/or non-volatile memory for storing computer readable data and instructions.

The processors and controllers described herein (and the activities they perform) may be implemented with fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

1. A sensor network comprising:
a controller; and
a plurality of sensor devices configured to be distributed about an area and to communicate via a wireless communication link with the controller,
wherein each sensor device is arranged to sense a parameter and to provide to the controller, via the wireless communication link, sensor data indicating a sensed parameter value; and
each sensor device is configured to report the sensor data to the controller according to a reporting condition associated with the each sensor device;
and wherein the controller is configured to:
obtain location data indicating the location of each of the plurality of sensor devices;
obtain said sensor data from each of the plurality of sensor devices;
determine a reporting command for a selected sensor device based on the obtained sensor data and the corresponding location data; and to
provide the reporting command to the selected sensor device to update the reporting condition associated with the selected sensor device.

2. The network of claim 1 wherein the controller is configured to determine a range of values associated with each sensor device, and to provide a reporting command to each sensor based on the range of values.

3. The network of claim 2 wherein the reporting condition comprises the range of values, wherein the sensor device is configured to determine whether to provide sensor data to the controller based on comparing the sensed parameter with the range of parameter values.

4. The network of claim 2 or 3 wherein the range of values comprises a spread about an expectation value, wherein the expectation value indicates an expectation value of the sensed parameter, and the spread indicates the expected spread of the sensed parameter values.

5. The network of claim 4 wherein the spread is based on sensor data associated with each sensor device.

6. The network of claim 5 wherein the expectation value is based on sensor data associated with each sensor device.

7. The network of claim 6 wherein the sensor data associated with each sensor device comprises sensor data obtained from at least one other sensor device of the plurality of sensor devices.

8. The network of claim 6 wherein the controller is configured to select the at least one other sensor device based on the location data.

9. The network of claim 8 wherein the at least one other sensor device comprises a nearest neighbour of the each sensor device.

10. The network of claim 9 wherein the spread is based on one of: (i) a statistical moment such as the variance; and (ii) a confidence interval of a model.

11. The network of claim 10 in which the expectation value and/or spread are determined based on a spatial map of the sensed parameter, the spatial map comprising a value of the parameter for each of a plurality of locations in the area.

12. The network of claim 11 in which the spatial map varies with time according to a temporal model of the sensed parameter for each of the plurality of locations.

13. The network of any preceding claim wherein the reporting condition is stored at the sensor device.

14. A method of operating a sensor network, the network comprising a controller, and a plurality of sensor devices each arranged at a different one of a corresponding plurality of locations and each configured to communicate via a wireless communication link with the controller, the method comprising:
obtaining sensor data from each of the plurality of sensor devices;
establishing an expectation value of the sensor data from a first sensor device of the plurality of sensor devices;
and, in the event that the sensor data from the first sensor device does not match the expectation value, sending a reporting command to a second sensor device of the plurality of sensor devices to cause the second sensor device to provide sensor data to the controller.

15. The method of claim 14 wherein obtaining sensor data comprises obtaining sensor data at a first reporting rate until the expectation value is established, and then reducing the reporting rate.

16. A method of operating a sensor network, the network comprising a controller, and a plurality of sensor devices each arranged at a different one of a corresponding plurality of locations and each configured to communicate via a wireless communication link with the controller, the method comprising: obtaining sensor data from each of the plurality of sensor devices;
establishing an expectation value of the sensor data from a first sensor device of the plurality of sensor devices,
wherein obtaining sensor data comprises obtaining sensor data at a first reporting rate until the expectation value is established, and then reducing the reporting rate.

17. The method of claim 15 or 16 wherein establishing the expectation value comprises determining that a spread of sensor data values is within a selected interval.

18. The method of claim 14, 15 or 16 wherein the expectation value is established based at least in part on parameter data obtained from a second data source, separate from the sensor network.

19. The method of any of claims 15 to 18 comprising increasing the reporting rate from the first sensor device in the event that sensor data from a second sensor device does not match its expectation value.

20. The method of any of claims 14 to 19 wherein the second sensor device is selected based on its location relative to the first sensor device, for example wherein the second sensor device is a nearest neighbour of the first sensor device.

21. The method of any of claims 14 to 20 comprising selecting at least two of said second sensor devices, and interpolating between measurements obtained from said second sensor devices to validate the sensor data from the first sensor device.

22. The method of any of claims 14 to 21 comprising:
determining a reporting command for a selected sensor device based on the obtained sensor data and the corresponding location data; and
providing the reporting command to the selected sensor device to update a reporting condition stored at the selected sensor device.

23. The method of claim 22 wherein the reporting condition comprises timing data and the selected sensor device is configured to provide sensor data to the controller according to the timing data.

24. The method of claim 21 or 23 wherein the reporting condition comprises a threshold and the selected sensor device is configured to determine when to provide sensor data to the controller based on comparing the sensor data with the threshold.

25. The method of claim 24 wherein the threshold defines a spread about an expectation value of the sensed parameter, and the spread indicates the expected spread of the sensed parameter values.

26. The method of claim 24 or 25 wherein the reporting condition is based on at least one of:
(a) previous sensor data obtained from the selected sensor device;
(b) sensor data obtained from a second sensor device; and
(c) forecast data.
